(19) United States
(12) Patent Application Publication
(10) Pub. No.: US 2017/0268757 A1
(43) Pub. Date: Sep. 21, 2017

(54) Adjustable Mounting Bracket

(71) Applicants: James Richard Christ, Peachtree City, GA (US); Christopher Michael Bryant, Covington, GA (US)

(72) Inventors: James Richard Christ, Peachtree City, GA (US); Christopher Michael Bryant, Covington, GA (US)

(21) Appl. No.: 14/973,339

(22) Filed: Dec. 17, 2015

Related U.S. Application Data
(60) Provisional application No. 62/095,666, filed on Dec. 22, 2014.

(51) Int. Cl. F21V 21/14; F21V 21/02

(52) U.S. Cl. CPC F21V 21/14; F21V 21/02

(57) ABSTRACT

A lighting fixture can be mounted to a structure near an obstacle that may constrain mounting options for the lighting fixture. An adjustable bracket can facilitate mounting the lighting fixture closer to the obstacle than would be workable without the adjustable bracket. A portion of the adjustable mounting bracket can translate rotationally and linearly. Using the translation capability, an installer can move the portion of the bracket away from the obstacle to provide room for attaching the fixture to the bracket. Once the fixture is attached, the installer can readjust the bracket to provide a long-term operating position, or the installer may leave the lighting fixture in a translated position relative to the bracket.

### CROSS REFERENCE TO RELATED APPLICATIONS

This application claims priority to U.S. Provisional Patent Application No. 62/095,666 filed Dec. 22, 2014 in the name of James Richard Christ and Christopher Michael Bryant and entitled “Adjustable Mounting Bracket,” the entire contents of which are hereby incorporated herein by reference.

### TECHNICAL FIELD

Embodiments of the technology relate generally to mounting brackets, and more particularly to adjustable brackets for mounting lighting fixtures.

### BACKGROUND

When installing a lighting fixture or luminaire, an installer can encounter obstacles that block or constrain mounting in a desired location. For example, trim boards, molding, water management components, etc. may interfere with or complicate conventional light-fixture mounting approaches. Addressing the issue with relocation of a fixture junction box from a cramped location to a site affording more space can present cost and labor disadvantages.

Accordingly, there are needs in the art for improved technologies for mounting lighting fixtures. Need exists for a technology to install a lighting fixture in cramped quarters, such as adjacent an obstacle. Further need exists for a technology to mount a lighting fixture flexibly, or to provide some positional adjustment after initial mounting. A capability addressing one or more such needs, or some other related deficiency in the art, would benefit lighting installations.

### SUMMARY

An adjustable mounting bracket can facilitate mounting a lighting fixture or luminaire near an obstacle that would otherwise complicate or prevent light-fixture mounting. The adjustable mounting bracket can comprise a member that may translate rotationally and linearly. Using the translation capability, an installer can move a portion of the bracket away from the obstacle to provide room for attaching the fixture to the bracket. Once the fixture is attached, the installer can readjust elements of the bracket to provide a long-term operating position, or the installer may leave the lighting fixture in a translated position relative to the bracket.

The foregoing discussion is for illustrative purposes only. Various aspects of the present technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE FIGURES

Reference will be made below to the accompanying drawings.

FIG. 1 is an illustration of an adjustable mounting bracket set in a nominal configuration in accordance with some example embodiments of the disclosure.

FIG. 2 is an illustration of the adjustable mounting bracket of FIG. 1 set in a linear offset configuration in accordance with some example embodiments of the disclosure.

FIG. 3 is an illustration of the adjustable mounting bracket of FIGS. 1 and 2 set in a configuration that includes linear offset and rotation in accordance with some example embodiments of the disclosure.

FIG. 4 is an illustration of a cross sectional schematic of the adjustable mounting bracket of FIGS. 1, 2, and 3 set in the nominal configuration in accordance with some example embodiments of the disclosure.

FIG. 5 is an illustration of a luminaire side of the adjustable mounting bracket of FIGS. 1, 2, 3, and 4, with the bracket set in a nominal configuration with mounting fasteners deployed for attachment to a mounting structure, in accordance with some example embodiments of the disclosure.

FIG. 6 is an illustration of a mounting-structure side of the adjustable mounting bracket of FIGS. 1, 2, 3, 4, and 5, with the bracket set in a nominal configuration with mounting fasteners deployed, in accordance with some example embodiments of the disclosure.

FIG. 7 is an illustration of a variation of the adjustable mounting bracket illustrated in FIGS. 1, 2, 3, 4, 5, and 6 in accordance with some example embodiments of the disclosure.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positionings may be exaggerated to help visually convey certain principles. In the drawings, similar reference numerals among different figures designate like or corresponding, but not necessarily identical, elements.

### DETAILED DESCRIPTION OF EXAMPLE EMBODIMENTS

A lighting fixture can be installed on a structure despite nearby obstacles, such as trim boards, molding, water management components, etc., that may interfere with or complicate conventional light-fixture mounting approaches. An adjustable mounting bracket enables light-fixture installation adjacent such obstacles that would otherwise confound installation or force relocation to a site affording more space. Accordingly, removal of a fixture junction box and relocation to a more spacious location can be avoided, thereby saving time and building material expenses associated with a new junction box position, for example new siding or soffit materials.

The adjustable mounting bracket can utilize friction between nested plates or fasteners to attenuate unwanted linear sliding and rotational adjustment, thereby supporting an installer's ability to configure the bracket to a preferred orientation prior to lighting fixture attachment. A central hole in front, middle, and rear members of the bracket can cooperate to provide a wire passageway for electrical connections to the lighting fixture. The wire passageway can avoid wire damage associated with bracket adjustment during installation. The adjustable bracket can further comprise a grounding screw for electrical grounding of the mounted lighting fixture.

Some representative embodiments will be described more fully hereinafter with example reference to the accompanying drawings that illustrate representative embodiments of the technology. The technology may, however, be embodied in many different forms and should not be construed as limited to the embodiments set forth herein; rather, these embodiments are provided so that this disclosure will be thorough and complete, and will fully convey the scope of the technology to those appropriately skilled in the art.

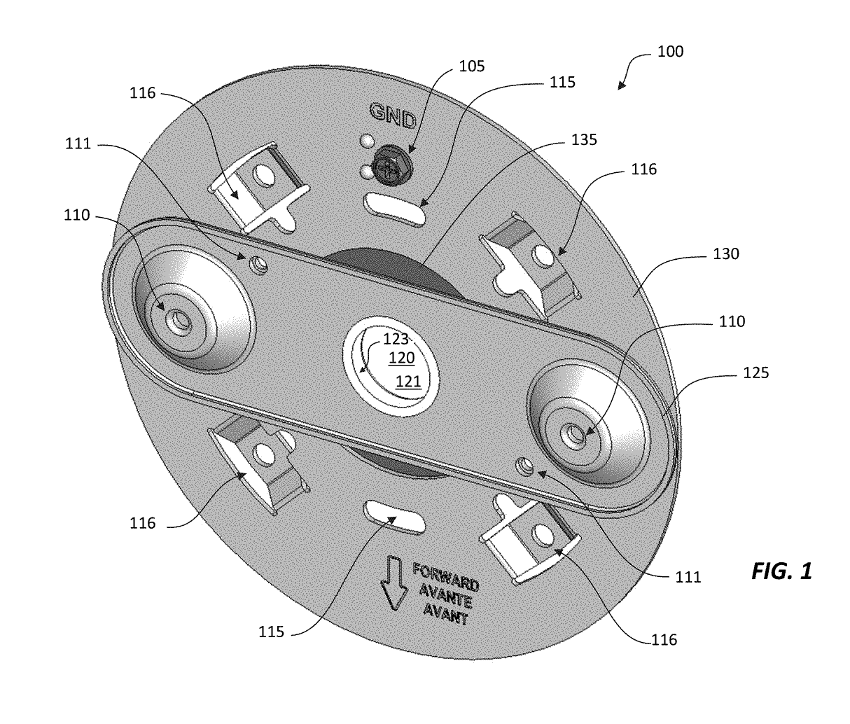

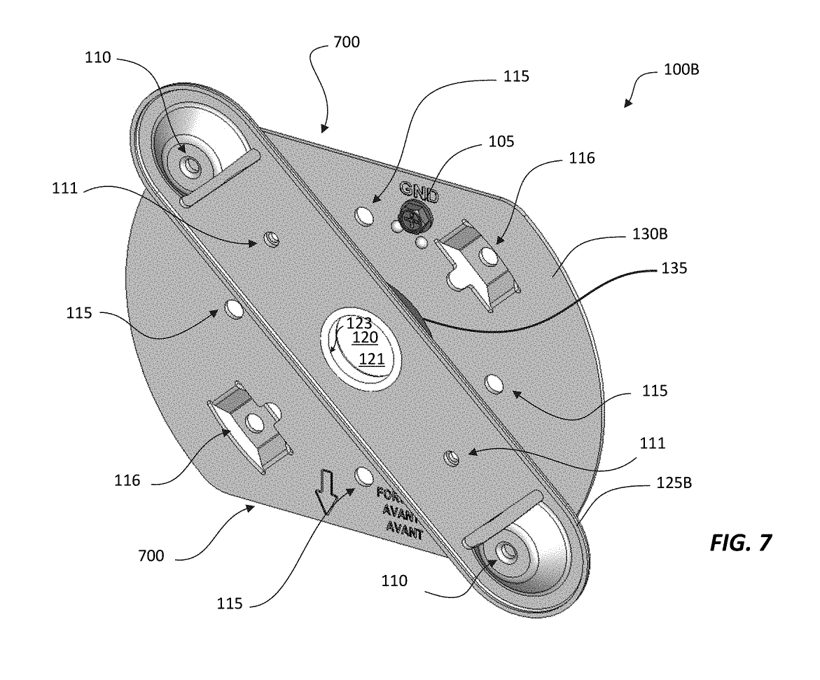

FIGS. 1, 2, 3, 4, 5, and 6 illustrate an example embodiment of an adjustable mounting bracket that supports linear and rotational translation after attachment to an installation structure. FIG. 7 illustrates a variation of the adjustable mounting bracket depicted in FIGS. 1-6.

Referring now to FIGS. 1, 2, 3, 4, 5, and 6, the illustrated example adjustable mounting bracket 100 comprises a middle plate 130, an arm 125, and a connection that joins the middle plate 130 and the arm 125 to one another. The middle plate 130 is typically attached to a ceiling, wall, or other mounting structure during lighting fixture installation. The arm 125 is attached to a lighting fixture or luminaire (not illustrated) during installation. As discussed in further detail below, the connection between the middle plate 130 and the arm 125 allows movement of the arm 125 (and the attached lighting fixture) after the middle plate 130 is attached to the mounting structure.

The arm 125 comprises two holes 110 that receive fasteners (not illustrated) for mounting the lighting fixture to the arm 125. In an example embodiment, the holes 110 may be threaded to mate with screws or bolts that extend through a supporting portion of the lighting fixture.

The arm 125 is attached to a rear plate 135 via a sleeve 123 that separates the arm 125 and the rear plate 135 from one another. As joined together, the arm 125, sleeve 123, and rear plate 135 provide an aperture 120. In an example embodiment, the aperture 120 is centrally located with respect to the rear plate 135, the sleeve 123, and the arm 125. As illustrated, the arm 125 and the rear plate 135 extend radially outward from the aperture 120.

In some embodiments, the sleeve 123 and the rear plate 135 are machined or otherwise formed from a unitary piece of metal or other suitable material. In some embodiments, the sleeve 123 and the arm 125 are machined or otherwise formed from a unitary piece of metal or other suitable material. In some embodiments, the sleeve 123 is welded to the arm 125, to the rear plate 135, or to the arm 125 and to the rear plate 135. In some embodiments, the sleeve 123 is held to one or both of the arm 125 and the rear plate 135 via material deformation, for example by swaging or crimping. In some embodiments, the sleeve 123 is held to one or both of the arm 125 and the rear plate 135 via a press fit or other suitable fastening means.

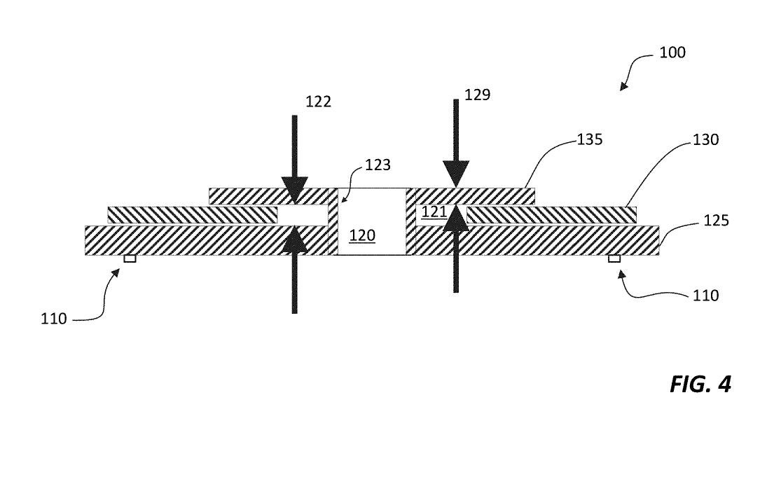

The adjustable mounting bracket 100 further comprises the middle plate 130 that is located in a gap 122 between the rear plate 135 and the arm 125. (See FIG. 4.) The rear plate 135 and the arm 125 confine, capture, or constrain the middle plate 130 within the gap 122 while allowing movement along a plane.

During light-fixture installation, the middle plate 130 can be fastened to a mounting structure or surface, such as a ceiling or wall. The middle plate 130 comprises mounting apertures 115 that are sized for screws, nails, or other fasteners, so that the installer can extend such fasteners through the apertures 115 and into a structure of a ceiling or wall. In the illustrated embodiment, the mounting apertures 115 comprise slots that arc circumferentially with respect to the center of the adjustable mounting bracket 100. The arc form of the mounting apertures 115 provides the installer a capability to rotate the middle plate 130 after the associated fasteners engage with the structure but before fully tightening the fasteners and setting the middle plate 130 into position.

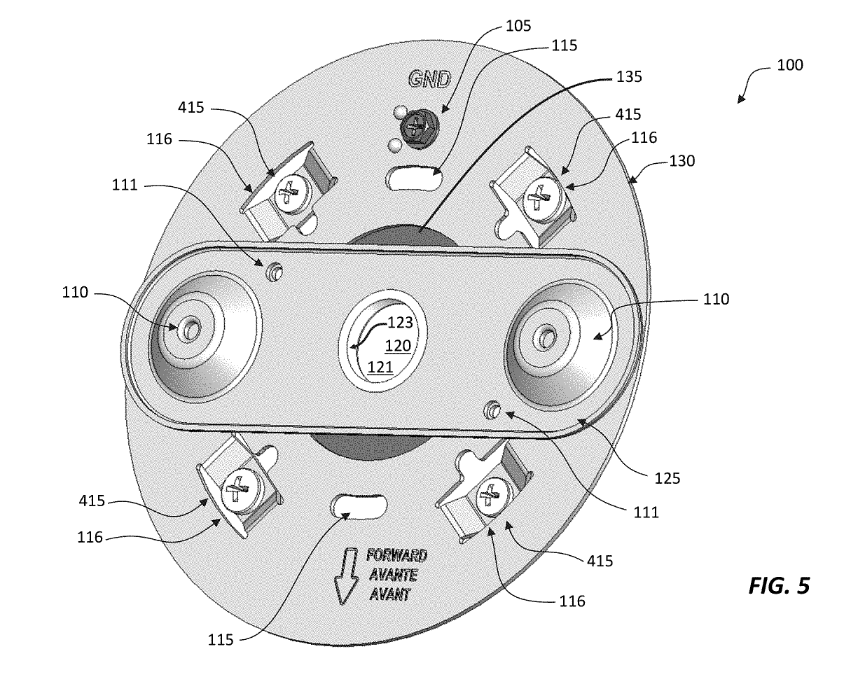

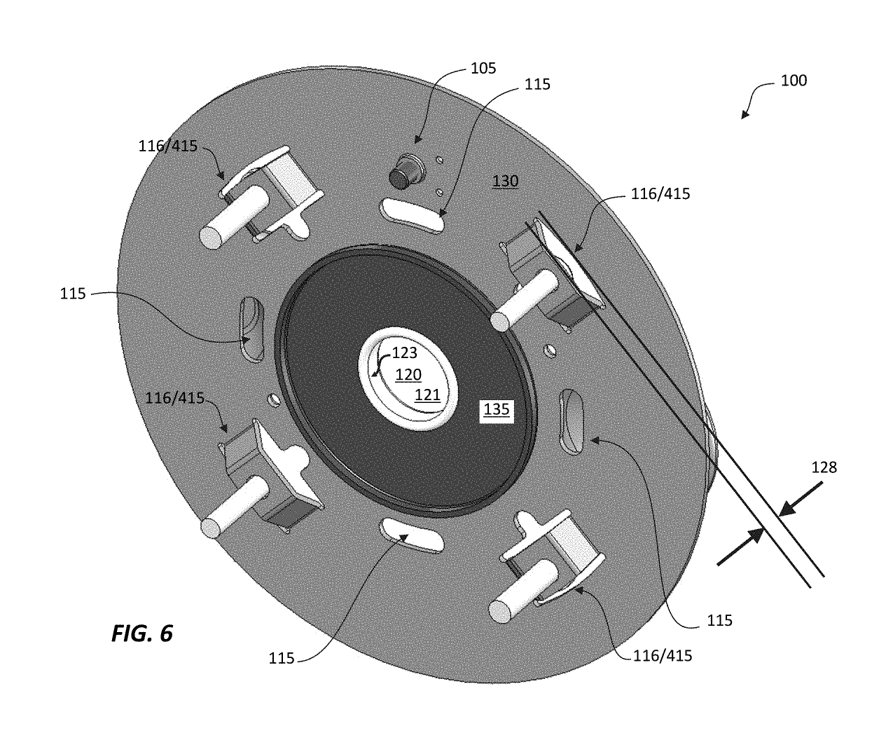

In the illustrated embodiment, the middle plate 130 further comprises recessed mounting apertures 116 for mounting the middle plate 130 to a ceiling, wall, or other structure. Each recessed mounting aperture 116 can be sized to accommodate a fastener 415, such as a nail, screw, or other fastening means, as illustrated in FIGS. 5 and 6, for example. The middle plate 130 is deformed adjacent each recessed mounting aperture 116 so that each aperture 116 is recessed a depth 128 (see FIG. 6) relative to the remaining surface of the middle plate 130. When the middle plate 130 is attached to a structure, the recessed depth 128 provides a standoff between the major portions of the middle plate and the structure. In other words, when the middle plate 130 is mounted to a surface, a gap corresponding to the depth 128 may exist between the middle plate and that surface. In an example embodiment, the gap (and the depth 128) is larger than the thickness 129 of the rear plate 135 (see FIG. 4). Dimensioning the gap/depth 128 larger than the thickness 129 of the rear plate 135 can provide a clearance that facilitates movement of the rear plate (and the attached arm 125) after the adjustable mounting bracket 100 is fastened to a wall, ceiling, or other mounting surface.

In addition to providing a standoff, in the illustrated embodiment, the recessed mounting apertures 116 can retain the mounting fasteners 415 with the adjustable mounting bracket 100 prior to bracket installation. Accordingly, an installer can position the adjustable mounting bracket 100 in place against a ceiling without having to worry about the mounting fasteners 415 falling out or becoming lost, regardless of the orientation of the adjustable mounting bracket 100.

The middle plate 130 comprises an aperture 121 through which the sleeve 123 extends. The aperture 121 is smaller in diameter than the rear plate 135, thus preventing the rear plate 135 from falling through the aperture 121. The arm 125 is likewise longer than the diameter of the aperture 121. Thus, the middle plate 130 is captured between the rear plate 135 and the arm 121.

Play between the middle plate 130 and the assembly of the arm 125, the sleeve 123, and the rear plate 135 provides two-dimensional linear motion between the middle plate 130 and the assembly as well as rotational motion. The two-dimensional motion can be in two perpendicular dimensions within a reference plane. The rotational motion can be about an axis that is substantially perpendicular to the reference plane.

Accordingly, the arm 125 (and the attached sleeve 123 and the rear plate 135) can be rotated and moved within a plane or linearly after the middle plate 130 is fixed in position to a wall, ceiling, or other mounting structure.

The installer can wire the lighting fixture by extending power lines from a junction box to the lighting fixture through the aperture 120. The adjustable bracket 100 includes a grounding screw 105, so the installer can readily attach a ground line to the adjustable bracket.

FIGS. 1, 4, 5, and 6 illustrate the arm 125 (and the rear plate 135 and the sleeve 123) centered with respect to one another, so that the aperture 120 and the aperture 121 are aligned and concentric. FIGS. 5 and 6 respectively illustrate the front and backside of the mounting bracket 100 with mounting fasteners 415 as discussed above. (In other words, FIG. 5 illustrates the side of the mounting bracket 500 that faces and attaches to a luminaire, while FIG. 6 illustrates the side that faces and attaches to a ceiling or other surface.)

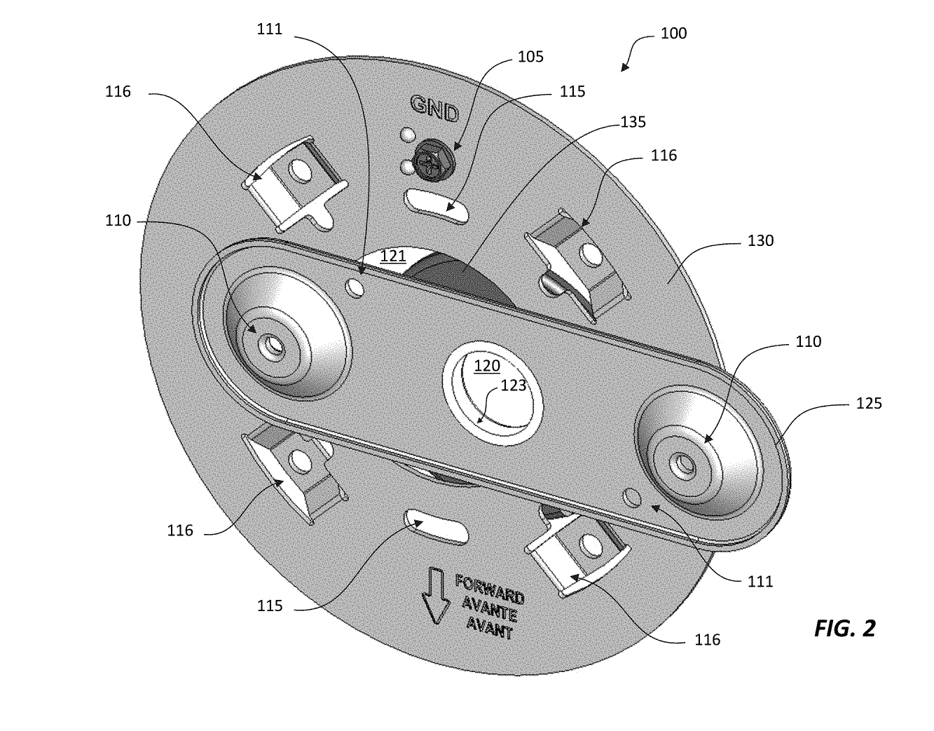

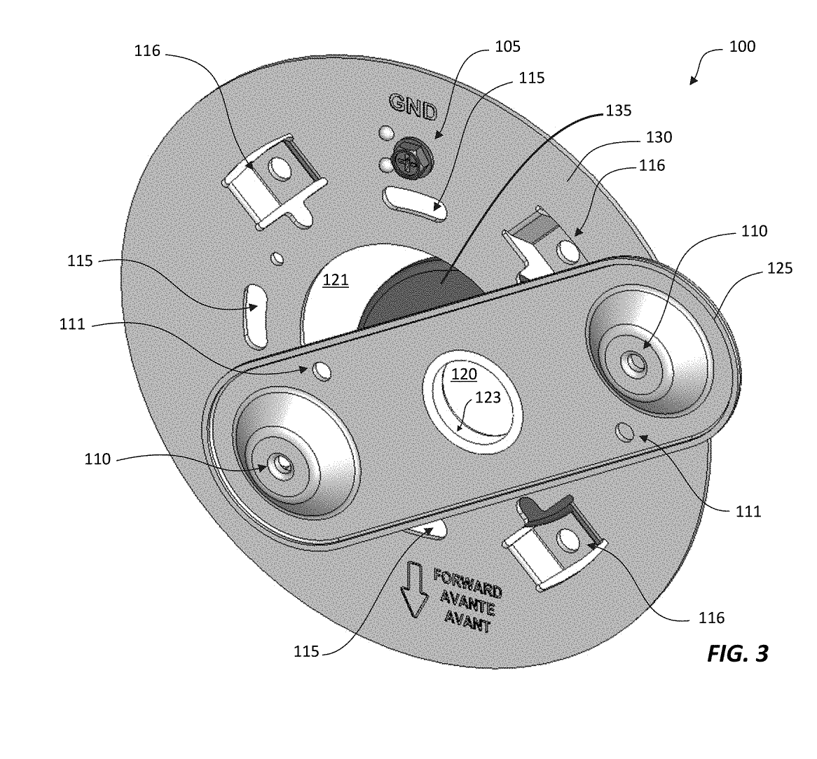

FIG. 2 illustrates the arm 123 (and the rear plate 135 and the sleeve 123) moved linearly (specifically radially translated) relative to the middle plate 130. FIG. 3 illustrates the arm 123 (and the rear plate 135 and the sleeve 123) moved linearly and rotationally relative to the middle plate 130.

Utilizing the linear and rotational translation capabilities illustrated by FIGS. 1, 2, and 3, the installer can attach the middle plate 135 to a mounting structure while maintaining rotational and linear freedom of motion of the arm 123. Once the adjustable mounting bracket 100 is mounted, the lighting fixture is attached, and the arm 125 is set to the desired configuration, the installer can lock the bracket 100 into a fixed position. To lock the adjustable mounting bracket 100 into the fixed position, the installer can screw bolts or screws into the threaded apertures 111 in the arm 125. Turning the screw in the threaded apertures 111 advances the screws through the arm 125 and against the middle plate 130. The resulting force or interference between the screws and the middle plate 130 fixes the position of the arm 125 relative to the middle plate 130 for long-term operation of the lighting fixture.

The resulting flexibility and adjustment provides the installer a capability to install the adjustable bracket 100 and the associated lighting fixture near objects or features that could otherwise interfere with the installation. The installer can wire a lighting fixture or luminaire to a junction box even if the junction box is already installed in a corner of a room, near the edge of a ceiling, or in some other space-constrained location.

Turning now to FIG. 7, this figure illustrates an example variation of the example adjustable mounting bracket 100 illustrated in FIGS. 1, 2, 3, 4, 5, and 6 according to some embodiments of the disclosure.

The adjustable mounting bracket 100B illustrated in FIG. 7 is configured to provide like functionality and similar general configuration to the bracket 100 illustrated in FIGS. 1-6 as discussed above. Corresponding components include, a middle plate 130B, a rear plate 135 (largely hidden in the view of FIG. 7), an arm 125B, recessed mounting apertures 116, mounting apertures 115, lighting fixture mounting holes 110, a ground 105, a sleeve 123, an aperture 120, an aperture 121, and so forth.

However, the middle plate 130B of the example adjustable mounting bracket 100B has two truncated areas 700 relative to the middle plate 130 of the bracket 100. The truncated areas 700 facilitate mounting the bracket 100 closer to obstacles. When the adjustable mounting bracket 100B is mounted to a ceiling, the straight edge of the truncated area 700 can be positioned adjacent a wall (where the wall and ceiling meet), for example. The arm 125B of the adjustable mounting bracket 100B also has a varied geometry relative to the arm 125 of the bracket 100. As illustrated, the arm 125B is longer relative to the width of the middle plate 130B.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A bracket for mounting a lighting fixture to a structure, the bracket comprising:
a first member that attaches to the structure and that comprises:
a first side that faces the structure when the first member is attached to the structure;
a second side opposite the first side; and
an aperture that extends between the first side and the second side; and
a second member comprising:
a first portion that extends along the first side of the first member adjacent the aperture;
a second portion that extends along the second side of the first member and that comprises a mount for the lighting fixture;
a third portion that extends through the aperture and joins the first portion and the second portion; and
a gap between the first portion and the second portion,
wherein the first member is disposed in the gap and is captured between the first portion and the second portion of the second member, and
wherein the first member is movable within the gap.

2. The bracket of claim 1, wherein the first member is movable in two linear dimensions within the gap.

3. The bracket of claim 1, wherein the gap defines a plane along which the first and second members are movable relative to one another.

4. The bracket of claim 1, wherein the first member is movable rotationally and laterally within the gap.

5. The bracket of claim 1, wherein the third portion of the second member comprises a second aperture sized to receive wiring for the lighting fixture.

6. The bracket of claim 1, wherein the first portion of the second member comprises a circular plate.

7. The bracket of claim 1, wherein the first portion of the second member is washer shaped, and
wherein the second portion of the second member is elongate.

8. The bracket of claim 1, wherein the second portion of the second member comprises an arm.

9. The bracket of claim 1, wherein the aperture has a diameter, and
wherein the first and second portions of the second member are larger than the diameter.

10. The bracket of claim 1, wherein the third portion of the second member comprises a sleeve.

11. The bracket of claim 1, wherein the second member is formed from at least two separate pieces of metal that are joined together.

12. The bracket of claim 1, wherein the bracket is configured for mounting the lighting fixture adjacent an interfering obstacle.

12. The bracket of claim 1, wherein the mount for the lighting fixture comprises a hole in the second portion of the second member.

13. An adjustable bracket for mounting a lighting fixture to a structure, the adjustable bracket comprising:
a plate comprising a central aperture and an aperture sized to receive a fastener for attaching the plate to the structure; and
a member that comprises:
a first portion disposed on a first side of the plate;
a second portion disposed on a second side of the plate; and
a third portion that extends through the central aperture and connects the first portion to the second portion,
wherein the second portion is configured for attaching to the lighting fixture, and
wherein the member has freedom of motion along a plane that extends along a surface of the plate.

14. The adjustable bracket of claim 13, wherein the third portion comprises a second aperture for wiring the lighting fixture.

15. The adjustable bracket of claim 13, wherein the plate is disk shaped.

16. The adjustable bracket of claim 13, wherein the first portion of the member is disk shaped.

17. The adjustable bracket of claim 13, wherein the second portion of the member is elongate.

18. The adjustable bracket of claim 13, wherein the first portion of the member and the second portion of the member form a gap that extends radially from the central portion, and
wherein the plate is captured in the gap while allowing said freedom of motion.

19. A bracket, for mounting a lighting fixture to a permanent structure, comprising:
a first member that is configured for mounting to the permanent structure;
a second member that is configured for attachment to the lighting fixture; and
a connection that connects the second member to the first member and that provides rotational and linear translation of the second member relative to the first member.

20. The bracket of claim 19, wherein said linear translation comprises linear translation in each of two perpendicular dimensions that define a reference plane, and
wherein said rotational positioning comprises rotation about an axis that is perpendicular to the reference plane.
